(19) United States
(12) Patent Application Publication
(10) Pub. No.: US 2017/0060301 A1
(43) Pub. Date: Mar. 2, 2017

(54) METHOD AND APPARATUS FOR SETTING SENSING THRESHOLD FOR A TOUCH SCREEN

(71) Applicant: Xiaomi Inc., Beijing (CN)

(72) Inventors: Guosheng Li, Beijing (CN); Kun Yang, Beijing (CN); Zhongsheng Jiang, Beijing (CN)

(73) Assignee: Xiaomi Inc., Beijing (CN)

(21) Appl. No.: 15/163,487

(22) Filed: May 24, 2016

(30) Foreign Application Priority Data
Aug. 31, 2015 (CN) 201510549404.0

(51) Int. Cl. G06F 3/044

(52) U.S. Cl. CPC G06F 3/044

(57) ABSTRACT

Methods and apparatus are disclosed for automatically and dynamically setting a reportable sensing threshold of touch panel in an electronic device based on ambient temperature. In one embodiment, a method comprises acquiring an ambient temperature of an electronic device, acquiring a reportable sensing threshold corresponding to the ambient temperature, and setting the reportable sensing threshold acquired as a current effective reportable sensing threshold of a touch panel. The reportable sensing threshold represents the sensitivity of the touch panel and is set automatically by the device rather than manually by the user. In such a way, user operational complexity is reduced and the reportable sensing threshold may be adaptively set according to ambient and use conditions.

### CROSS-REFERENCE TO RELATED APPLICATIONS

This application is based on and claims priority to Chinese Patent Application Serial No. CN 201510549404.0, filed with the State Intellectual Property Office of P. R. China on Aug. 31, 2015, the entire content of which is incorporated herein by reference.

### TECHNICAL FIELD

The present disclosure generally relates to a touch screen, and more particularly, to a method and an apparatus for setting a touch sensing threshold.

### BACKGROUND

Typically, a touch screen and a touch IC (integrated circuit) are included in an electronic device. When a touch signal is generated by the touch screen in response to a touch by a finger of a user, the touch IC may determine whether the signal strength of the touch signal reaches a reportable sensing threshold. If the signal strength of the touch signal reaches the reportable sensing threshold, the touch IC reports the touch event to a processor. The reportable sensing threshold may represent a sensitivity of the touch screen. If the sensitivity is too low, the touch screen responds slowly. If the sensitivity is too high, false touches may be reported. In winter, when a user wearing gloves uses the touch screen, the reportable sensing threshold may be different from summer. In the related art, a glove mode with three options: thin, middle, and thick, are provided. Each option corresponds to a different reportable sensing threshold. The user may set the option manually.

### SUMMARY

The present disclosure provides methods and an apparatus for setting a reportable sensing threshold for touch panels.

In one embodiment, a method is provided for automatically setting a current reportable sensing threshold for a touch panel in an electronic device, comprising acquiring a current ambient temperature of the electronic device, acquiring a reportable sensing threshold corresponding to the current ambient temperature, and setting the acquired reportable sensing threshold as the current reportable sensing threshold of the touch panel in the electronic device, wherein a reportable sensing threshold for the touch panel is a signal threshold for a touch signal above which the touch signal is reported to the electronic device as a valid touch signal intended by a user.

In another embodiment, an apparatus is provided for setting a reportable sensing threshold for a touch panel, comprising a memory having instructions stored therein, and one or more processors, when executing the instructions, configured to acquire a current ambient temperature, acquire a reportable sensing threshold corresponding to the current ambient temperature, and set the acquired reportable sensing threshold as the current reportable sensing threshold of the touch panel, wherein a reportable sensing threshold for the touch panel at least partially determines the sensitivity of the touch panel.

In yet another embodiment, a non-transitory computer-readable storage medium is disclosed. The storage medium has stored therein instructions that, when executed by a processor of an electronic device, causes the device to acquire a current ambient temperature of the electronic device, acquire a reportable sensing threshold for a touch panel of the electronic device corresponding to the current ambient temperature, and set the acquired reportable sensing threshold as the current reportable sensing threshold of the touch panel, wherein a reportable sensing threshold for the touch panel is a signal threshold for a touch signal above which the touch signal is reported to the electronic device as a valid touch signal intended by a user.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a block diagram for a device comprising a touch panel and associated circuits.

FIG. 2 is a flow chart showing of a method for setting a reportable sensing threshold according to an example embodiment.

FIG. 3A-3D is a flow chart showing a method for setting a reportable sensing threshold according to another example embodiment.

FIG. 4A-4B is a flow chart showing a method for setting a reportable sensing threshold according to yet another example embodiment.

FIG. 5 is a block diagram of an apparatus for setting a reportable sensing threshold according to an example embodiment.

FIG. 6 is a block diagram of an apparatus for setting a reportable sensing threshold according to another example embodiment.

FIG. 7 is a block diagram of an apparatus for setting a reportable sensing threshold according to another example embodiment.

FIG. 8 is a block diagram of an apparatus for setting a reportable sensing threshold according to yet another example embodiment.

FIG. 9 is a block diagram of an apparatus for setting a reportable sensing threshold according to yet another example embodiment.

FIG. 10 is a block diagram of a device for setting a reportable sensing threshold according to an example embodiment.

### DETAILED DESCRIPTION

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

The methods, devices, and modules described herein may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Subject matter will now be described in more detail hereinafter with reference to the accompanying drawings in which the same numbers in different drawings represent the same or similar elements unless otherwise represented. The drawings form a part hereof, and show, by way of illustration, specific exemplary embodiments. Subject matter may, however, be embodied in a variety of different forms and, therefore, covered or claimed subject matter is intended to be construed as not being limited to any exemplary embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

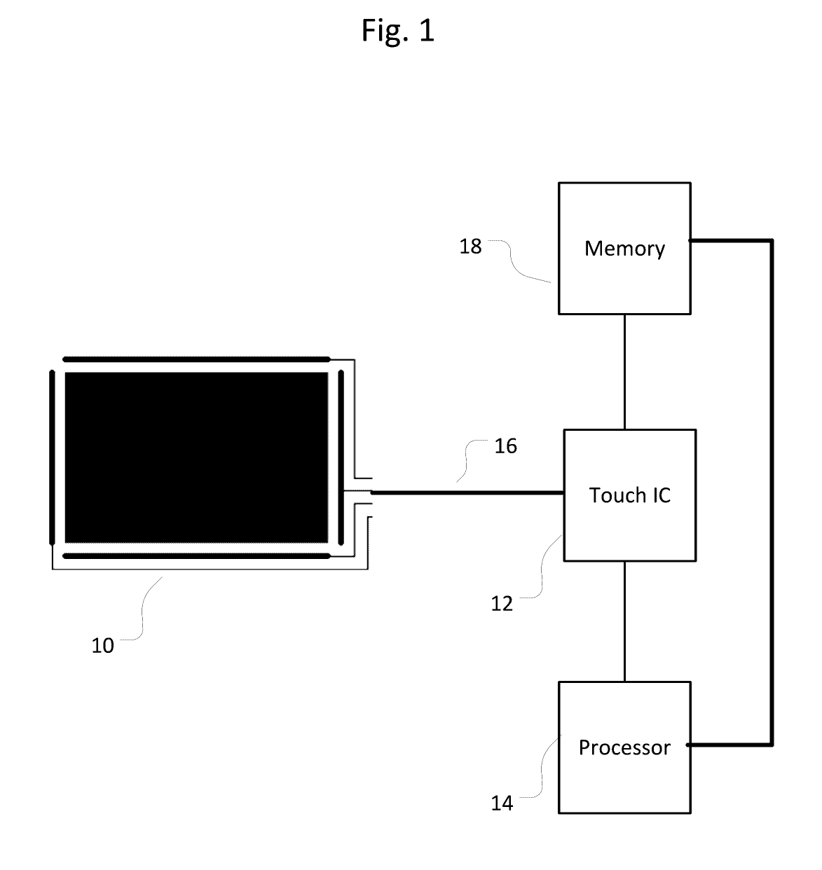

By way of introduction, a touch screen subsystem of an electronic device is designed as an input device for detecting user touch actions. As illustrated in FIG. 1, a touch screen system may include a touch panel 10 in communication with a touch IC (or a touch controller circuit) 12. The touch IC 12 in turn is in communication with a processor or processing unit 14 (referred to herein as “processor”) of the electronic device. The touch IC may be referred to as a processor of the touch panel. A user interacts with the electronic device via touch actions on the touch panel. User touch actions may take various forms, such as swiping and clicking. Each user touch action produces a set of touch signals (herein also referred to as “signal”) 16 on the touch panel 10. The set of touch signals 16 is communicated to the touch IC 12. The set of touch signals 16 for a touch action may include signal corresponding to the physical characteristics of the touch action, such as touch pressure, contact length, swiping speed, swiping direction, clicking speed (for double clicks, for example), and touch dwell time.

To avoid detecting false touch actions due to, for example, noise signal from the touch panel 10 or slight touch of the touch panel unintended as a touch action, the touch IC may analyze the received touch signal and compare it to a predetermined reportable sensing threshold. If the touch signal is at or above the reportable sensing threshold, the touch IC determine the touch action from the touch signal and report the touch action to the processing unit. However, if the touch signal is below the reportable sensing threshold, the touch IC may ignore the touch signal and deem the touch an unintended touch action. The touch signal and the corresponding threshold may be any one or combination of absolute or change of amplitude or duration of current, voltage, or capacitance. Those of ordinary skill in the art understand that the touch panel and IC may monitor strength, duration and any other suitable characteristics of various types of electric signal produced by touch actions on the touch panel not limited by the examples above. Each recognized user touch action reported to the processor 14 may correspond to a predefined operation that the electronic device will perform. The reportable sensing threshold may be stored in a memory 18 for the electronic device and provided to the touch IC upon request or it may alternatively be computed or determined by the processor via certain algorithm. The reportable sensing threshold may be static threshold corresponding to the physical and electrical characteristics of the touch panel. It may alternatively be dependent on touch habit of a particular user and thus may be determined through a learning process. As will be shown below, the reportable sensing threshold may vary from time to time, from season to season, depending on the ambient and other factors. The embodiments described below disclose methods and devices that automatically sense the ambient conditions and other factors and dynamically set the reportable sensing threshold for more accurate determination of intended touch actions by the user. Ambient conditions may include but are not limited to temperature, humidity, lighting condition, and device location. The reportable sensing threshold may be selected based on the ambient condition from a plurality of sensing thresholds stored in the memory 18 corresponding to a plurality of various possible ambient conditions.

Methods for setting a sensing threshold provided in embodiments of the present disclosure is applicable to any electronic device having a touch screen. The electronic device may be but is not limited to a mobile phone, a panel computer, an electronic book reader, a MP3 (Moving Picture Experts Group Audio Layer III) player, a MP4 (Moving Picture Experts Group Audio Layer IV) player, a laptop portable computer and a desk-top computer. The electronic device may further include a temperature sensor, a location sensor or both. The temperature sensor may be referred to as a thermometer and the two terms are used interchangeably.

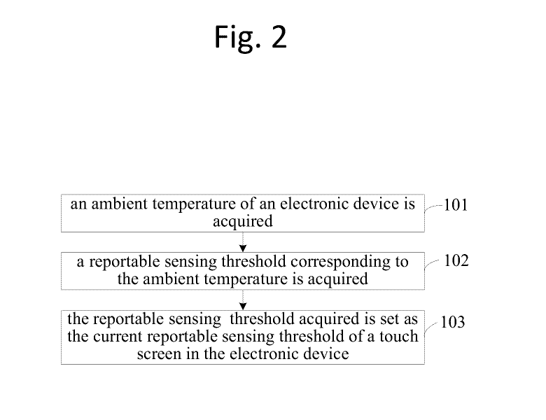

FIG. 2 is a flow chart showing a method for setting a current effective sensing threshold according to an example embodiment. In step 101, an ambient temperature of the electronic device is acquired. In step 102, a reportable sensing threshold corresponding to the ambient temperature is queried and acquired. In step 103, the acquired reportable sensing threshold is set as the current effective reportable sensing threshold of the touch screen in the electronic device.

Thus, method of FIG. 2 sets the current effective reportable sensing threshold, by acquiring the ambient temperature of the electronic device, querying and acquiring a reportable sensing threshold corresponding to the ambient temperature, and setting the acquired reportable sensing threshold as the current effective reportable sensing threshold of the touch screen in the electronic device. Thus, in the embodiment of FIG. 2, the current effective reportable sensing threshold of the touch screen is automatically set to a reasonable level according to the ambient temperature rather than being set via manual selection by the user. In such a way, user operational complexity is reduced and the reportable sensing threshold setting is adaptive. For example, the reportable sensing threshold may strongly depend on the thickness of gloves that the user may wear outdoors in winter and may be correlated with the ambient temperature. Thus, by monitoring the ambient temperature, the device may automatically set a reasonable reportable sensing threshold taking into consideration the glove thickness corresponding to the measured ambient temperature.

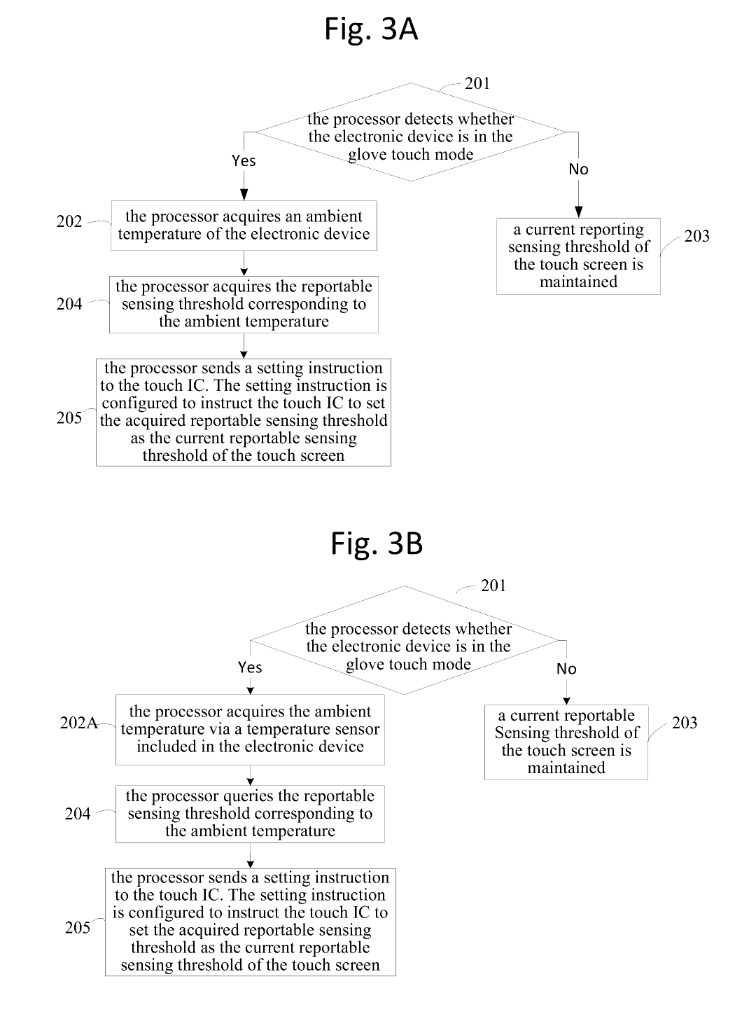

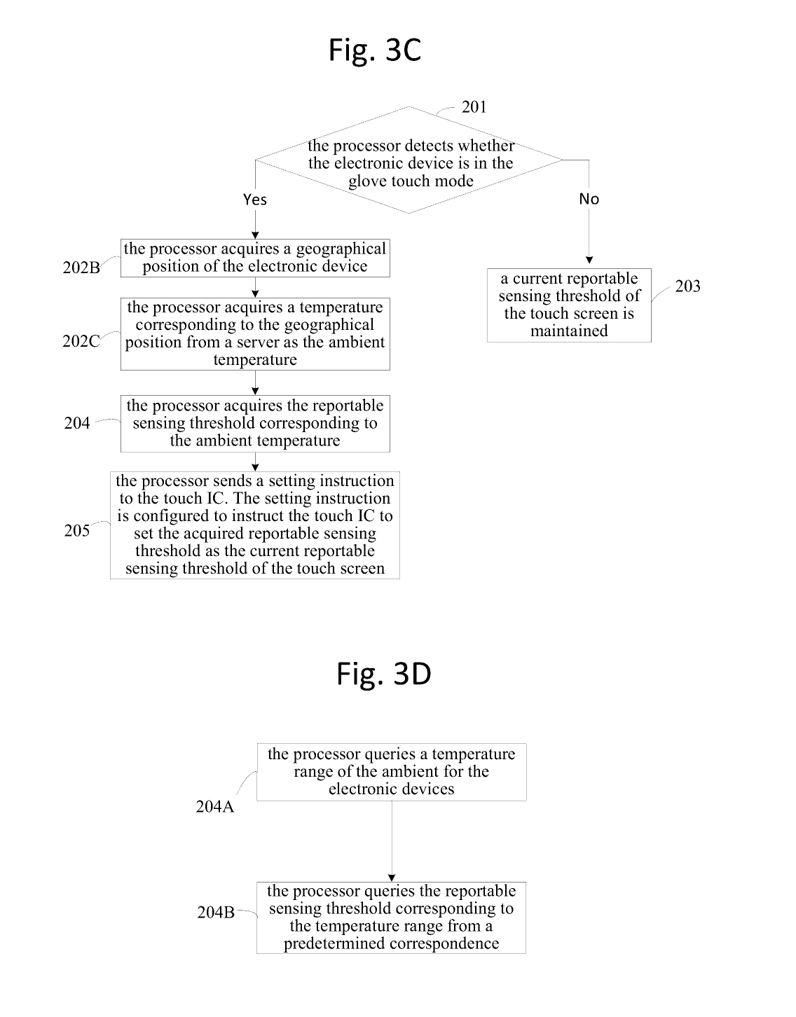

FIG. 3A is a flow chart showing a method for setting a current effective reportable sensing threshold according to another exemplary embodiment. In step 201, a processor detects whether the electronic device is in a glove touch mode. If the electronic device is in the glove touch mode, step 202 is executed. Otherwise, step 203 is executed.

Based on the operational principles of a touch panel, the touch screen may be set in either the glove mode or non-glove mode. Specifically, a capacitive touch screen technology is based on electrical current induction. When a human finger contacts the touch screen, a coupling capacitor is formed between the finger and the capacitive touch panel since the human is grounded, and the coupling capacitor may absorb some current from the touch panel. The current will flow through the contact point. If the total current flowing through the contact point reaches some value (i.e., the reportable sensing threshold), the processor or the touch IC in the electronic device may calculate accurately the position of the contact point according to a ratio and strength of the currents flowing through various electrodes distributed on the touch panel. The electronic device may track such position of the finger as it move on the touch panel.

In order to avoid detection of false touch actions, typically, the reportable sensing threshold of the touch screen is set to a relatively high value. The higher the reportable sensing threshold, the lower the sensitivity of the touch detection. When a person wearing gloves performs a touch action on an electronic device having a touch screen (such as, a mobile phone) in winter, the distance between the finger and the touch panel is increased and the contact area between the finger and the touch panel is reduced by the gloves, such that the capacitance of the coupling capacitor is small and the current flowing through the contact is weak. If the strength of the signal representing the current flowing through the contact is below the reportable sensing threshold, the touch IC ignores the signal and the processor will not respond to the touch action issued by the person wearing gloves. Thus the glove mode may be employed to increase the sensitivity of the touch screen. For example, the threshold for electric current (or any other electrical signal) may be set differently in the glove mode (compared to non-glove mode) to allow for more sensitive touch recognition.

In step 202 if FIG. 3A, the processor acquires an ambient temperature of the electronic device. In one alternative of the embodiment of FIG. 3A, as shown in FIG. 3B, step 202 may be implemented as step 202A, in which the processor directly acquires the ambient temperature via a temperature sensor included in the electronic device. In a second alternative of the embodiment of FIG. 3A, as shown in FIG. 3C, step 202 may be implemented as sub-steps 202B and 202C. In sub-step 202B, the processor acquires a geographical position of the electronic device via the location sensor in the electronic device. In one example, the processor acquires the geographical position of the electronic device using a Global Positioning System sensor embedded in the electronic device. In sub-step 202C, the processor acquires a temperature corresponding to the geographical position from a server as the ambient temperature via a network connection. The server may be a weather server providing real-time temperature information in various areas including the area where the electronic device is located.

In step 203 of FIG. 3A (and its alternatives FIG. 3B and FIG. 3C), when the electronic device is not in the glove mode, a current and normal reportable sensing threshold of the touch screen is maintained. A normal default reportable sensing threshold may be a value stored in the device memory or a register.

In step 204 of FIG. 3A (and its alternatives FIG. 3B and FIG. 3C), when the electronic device is in the glove mode, the processor acquires a reportable sensing threshold corresponding to the ambient temperature. In one implementation, as shown in FIG. 3D, step 204 includes sub-steps 204A and 204B. In sub-step 204A, the processor queries a temperature range to which the ambient temperature belongs. The processor may estimate the thickness range of gloves used by the user according to the temperature range. In sub-step 204B, the processor queries a reportable sensing threshold corresponding to the temperature range from a predetermined correspondence between ambient temperature ranges and reportable sensing thresholds. Specifically, since various temperature ranges correspond to various thicknesses of gloves, they also correspond to various reportable sensing thresholds. Each reportable sensing threshold may be derived according to the thickness of the gloves used by the user in some temperature range, and the derivation may be performed by the developer via experiments in advance. The predetermined correspondence between temperature ranges and reportable sensing thresholds may be pre-stored in, for example, a lookup table and the processor may simply look up the acquired temperature range in the lookup table and identify the corresponding reportable sensing threshold in sub-step 204B. Alternatively, the predetermined correspondence may be formulaic and determined via experiments.

The correspondence between temperature ranges and reportable sensing thresholds may be one to one. Alternatively, a plurality of temperature ranges may correspond to one reportable sensing threshold. An exemplary correspondence relation between various temperature ranges and reportable sensing thresholds is shown in Table 1. The reportable sensing thresholds A-D of Table 1 may be thresholds for electric current drawn from touch contact spots on the touch panel or other electrical signal. Thus, they may be in units of, for example, electric current.

TABLE 1

| temperature range | reportable sensing threshold |
|---|---|
| −20° C.~−11° C. | A |
| −10° C.~−1° C. | B |
| 0° C.~10° C. | C |
| 11° C.~20° C. | D |

In step 205 of FIG. 3A (and its alternatives FIG. 3B and FIG. 3C), the processor sends a setting instruction to the touch IC. The setting instruction is configured to instruct the touch IC to set the acquired reportable sensing threshold as the effective reportable sensing threshold of the touch screen. In other words, the setting instruction instructs the touch IC to replace the previously used reportable sensing threshold with the newly acquired reportable sensing threshold as the current effective reportable sensing threshold. The touch IC may store the current reportable sensing threshold in its memory or data register.

For example, if the current temperature is 2° C., the processor acquires the reportable sensing threshold C (see Table 1), and sends the setting instruction to the touch IC. The setting instruction is configured to instruct the touch IC to set the current reportable sensing threshold to C of Table 1.

Thus, in the embodiments of FIG. 3, the current reportable sensing threshold is set automatically by acquiring the ambient temperature of the electronic device, acquiring a reportable sensing threshold corresponding to the ambient temperature, and setting the acquired reportable sensing threshold as the current effective reportable sensing threshold of the touch screen in the electronic device, rather than manually by the user. In such a way, user operational complexity is reduced and the reportable sensing threshold setting is adaptive.

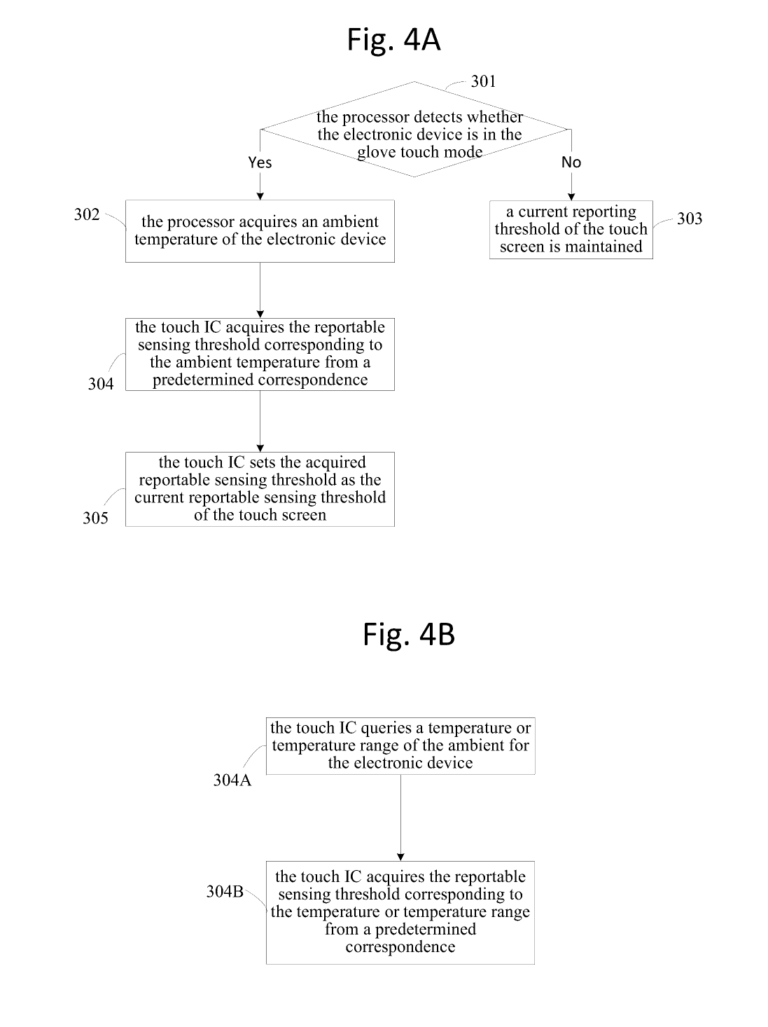

FIG. 4A is a flow chart showing a method for setting a reportable sensing threshold according to yet another exemplary embodiment. This embodiment is similar to FIG. 3 except that the touch IC rather than the processer carries out most of the functions. In step 301, the processor detects whether the electronic device is in the glove touch mode. If the electronic device is in the glove touch mode, step 302 is executed. Otherwise, step 303 is executed.

In step 302 of FIG. 4A, the processor acquires an ambient temperature of the electronic device. This step is identical to step 202 of FIG. 3A and the description for step 202 applies to step 302. Correspondingly, the same alternative step 202A of FIG. 3B and the same alternative sub-steps 202B and 202C to the step 202 of FIG. 3C apply as alternatives to step 302. Thus, description for step 202A, 202B, and 202C of FIG. 3B and FIG. 3C applies.

In step 303 of FIG. 4A, when the electronic device is not in the glove mode, a current normal reportable sensing threshold of the touch screen is maintained, similar to step 203 of FIG. 3A (and its alternatives FIG. 3B and FIG. 3C).

In step 304, when the electronic device is in the glove mode, the touch IC (rather than the processor) queries a reportable sensing threshold corresponding to the acquired ambient temperature. In one implementation, as shown in FIG. 4B, step 304 includes sub-steps 304A and 304B. In sub-step 304A, the touch IC (rather than the processor) queries a temperature range to which the acquired ambient temperature belongs. The touch IC may estimate the thickness range of gloves used by the user according to the temperature range. In sub-step 304B, the touch IC queries a reportable sensing threshold corresponding to the temperature range from a predetermined correspondence between ambient temperature ranges and reportable sensing thresholds. Specifically, since various temperature ranges correspond to various thicknesses of gloves, they also correspond to various reportable sensing thresholds. Each reportable sensing threshold may be derived according to the thickness of the gloves used by the user in some temperature range, and the derivation may be performed by the developer via experiments in advance. The predetermined correspondence between temperature ranges and reportable sensing thresholds may be pre-stored in, for example, a lookup table and the touch IC may simply looks up the acquired temperature range in the lookup table and identify the corresponding reportable sensing threshold in sub-step 304B.

The correspondence between temperature ranges and reportable sensing thresholds may be one to one. Alternatively, a plurality of temperatures or temperature ranges may correspond to one reportable sensing threshold. An exemplary correspondence between some temperature ranges and reportable sensing thresholds are shown below in Table 2.

TABLE 2

| temperature range | reportable sensing threshold |
|---|---|
| −30° C.~−11° C. | A |
| −10° C.~−1° C. | B |
| 0° C.~10° C. | C |
| 11° C.~30° C. | D |

In step 305 of FIG. 4A, the touch IC sets the acquired reportable sensing threshold as the current effective reportable sensing threshold of the touch screen. For example, if the current temperature is −1° C., the touch IC acquires the reportable sensing threshold B of Table 2, and sets the current effective reportable sensing threshold to B.

Thus, in embodiment of FIG. 4A, the current reportable sensing threshold is set automatically by acquiring the ambient temperature of the electronic device, acquiring a reportable sensing threshold corresponding to the ambient temperature, and setting the reportable sensing threshold acquired as the current reportable sensing threshold of the touch screen in the electronic device, rather than manually by the user. In such a way, user operational complexity is reduced and the reportable sensing threshold setting is adaptive.

The method embodiments above may be implemented in the following device embodiments. For details not disclosed in the device embodiments below, reference is made to the method embodiments of the present disclosure.

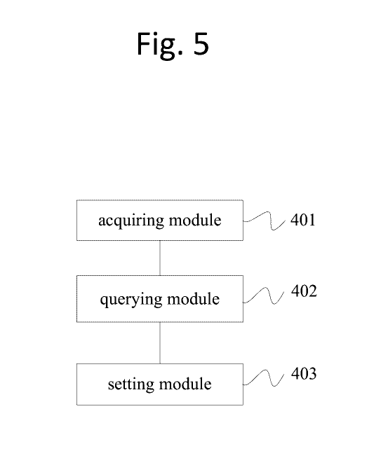

FIG. 5 is a block diagram of an apparatus for setting a reportable sensing threshold according to an exemplary embodiment. As shown in FIG. 5, the apparatus for setting a current reportable sensing threshold includes, but is not limited to an acquiring module 401, a querying module 402 and a setting module 403. The acquiring module 401 is configured to acquire an ambient temperature of an electronic device. The querying module 402 is configured to query and acquire a reportable sensing threshold corresponding to the ambient temperature. The setting module 403 is configured to set the acquired reportable sensing threshold as a current reportable sensing threshold of a touch screen in the electronic device. Thus, in the apparatus embodiment of FIG. 5, the current reportable sensing threshold of the touch screen is automatically set to a reasonable level according to the ambient temperature of the electronic device rather than being set via manual selection by the user. In such a way, user operational complexity is reduced and the reportable sensing threshold setting is adaptive. For example, the reportable sensing threshold may strongly depend on the thickness of gloves that the user wears outdoors in winter and may be correlated with the ambient temperature. Thus, by monitor the ambient temperature, the device may automatically set a reasonable current reportable sensing threshold taking into consideration the glove thickness corresponding to the measured temperature.

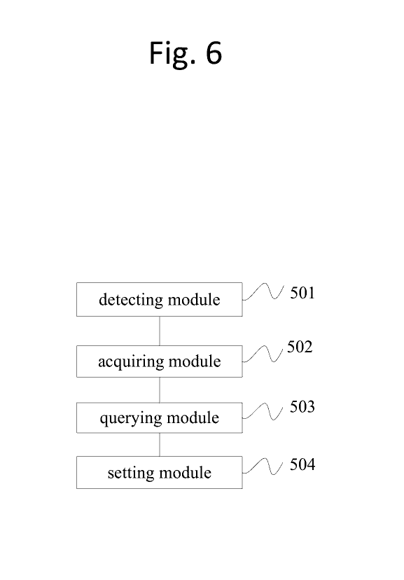

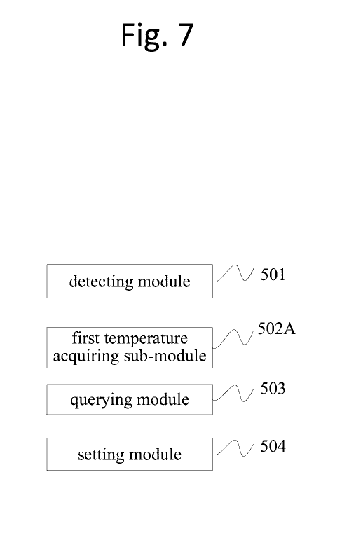

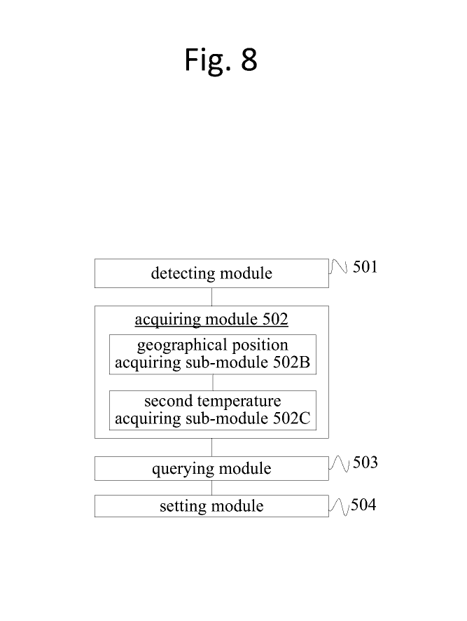

FIG. 6 is a block diagram of an apparatus for setting a reportable sensing threshold according to another exemplary embodiment. As shown in FIG. 6, the apparatus for setting a sensing threshold includes, but is not limited to a detecting module 501, an acquiring module 502, a querying module 503 and a setting module 504. The detecting module 501 is configured to detect whether the electronic device is in a glove touch mode. The acquiring module 502 is configured to acquire an ambient temperature of an electronic device. The acquiring module 502 may have various alternative embodiments. In one alternative, as shown in FIG. 7, the acquiring module 502 may be implemented as a first temperature acquiring sub-module 502A configured to directly acquire the ambient temperature from a temperature sensor embedded in the electronic device. In another alternative, as shown in FIG. 8, the geographical position acquiring sub-module 502B is configured to acquire a geographical position of the electronic device. The second temperature acquiring sub-module 502C is configured to acquire a temperature corresponding to the geographical position from a server as the ambient temperature via a network connection. The server may be a weather server providing real-time temperature information in various areas including the area where the electronic device is located.

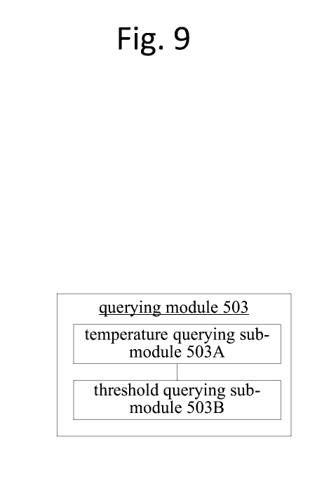

The querying module 503 is configured to query and acquire a reportable sensing threshold corresponding to the ambient temperature. In one implementation, as shown in FIG. 9, the querying module 503 includes a temperature querying sub-module 503A and a reportable sensing threshold querying sub-module 503B. The temperature querying sub-module 503A is configured to query a temperature range to which the ambient temperature belongs. The reportable sensing threshold querying sub-module 503B is configured to query and acquire a reportable sensing threshold corresponding to the temperature range from a predetermined correspondence between ambient temperature ranges and reportable sensing thresholds.

The setting module 504 is configured to set the acquired reportable sensing threshold as the current effective reportable sensing threshold of the touch screen in the electronic device. In one implementation, the setting module 504 is configured to send a setting instruction to a touch IC by a processor of a mobile terminal if the reportable sensing threshold is acquired by the processor, wherein the setting instruction is configured to instruct the touch IC to set the acquired reportable sensing threshold as the current effective reportable sensing threshold of the touch screen. In another implementation, the setting module 504 is configured to set the acquired reportable sensing threshold as the current effective reportable sensing threshold of the touch screen if the reportable sensing threshold is acquired directly by the touch IC.

Thus in the embodiment of FIG. 6 (and its implementations in FIG. 7-9), the current effective sensing threshold is set automatically by acquiring the ambient temperature of the electronic device, acquiring the reportable sensing threshold corresponding to the ambient temperature, and setting the reportable sensing threshold acquired as the current effective reportable sensing threshold of the touch screen in the electronic device, rather than manually by the user. In such a way, user operational complexity is reduced and the reportable sensing threshold setting is adaptive.

With respect to the apparatus in the above embodiments, the specific manners for performing operations for individual modules therein have been described in detail in the embodiments regarding the method, which will not be elaborated herein.

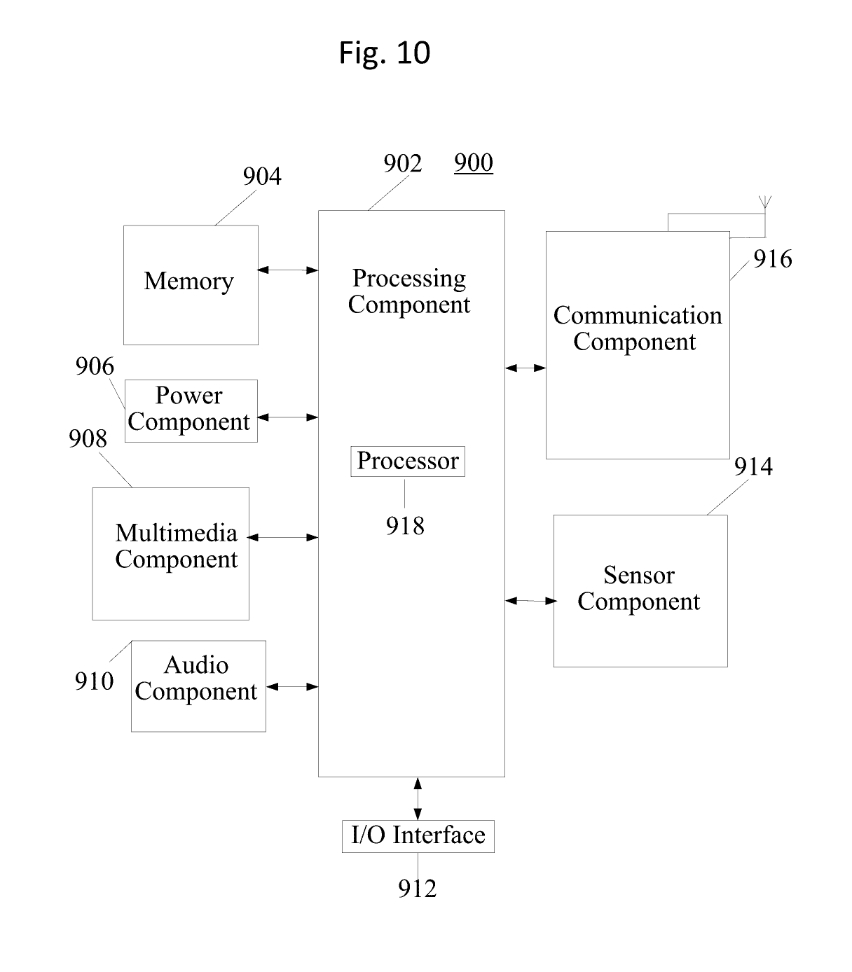

FIG. 10 is a block diagram of a device for setting a reportable sensing threshold according to an exemplary embodiment. For example, the device 900 may be an electronic device having a capacitive touch screen, such as a smart phone, a panel computer, an electronic book reader, a personal digital assistant, a laptop portable computer, and the like.

Referring to FIG. 10, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 918 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output or input interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia information while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 may include a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor or accelerometer, a gyroscope sensor, a magnetic sensor, a pressure sensor, or a temperature sensor or thermometer.

The communication component 916 is configured to facilitate communication, wired or wirelessly, between the device 900 and other devices. The device 900 can access a wireless network based on a communication standard, such as WiFi, 2G, 3G, 4G, or LTE cellular networks, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as a memory 904 including instructions. The instructions may be executable by the processor 918 in the device 900, for performing the above-described methods. The non-transitory computer-readable storage medium may be a ROM, a RAM, a CD-ROM, a magnetic tape, a floppy disc, an optical data storage device, and the like.

The non-transitory computer-readable storage medium having stored therein instructions that, when executed by a processor of the device 900, causes the device 900 to perform a method for setting a reportable sensing threshold. Specifically, the processor 918, when executing the instructions, is configured to acquire an ambient temperature of an electronic device, query and acquire a reportable sensing threshold corresponding to the ambient temperature, and set the acquired reportable sensing threshold as a current effective

Each module or unit discussed above for FIG. 7-10, such as the acquiring module, the querying module, the setting module, the detection module, the first temperature acquiring sub-module, the geographical position acquiring sub-module, the second temperature acquiring sub-module, the temperature quering sub-module, and the threshold querying sub-module, may take the form of a packaged functional hardware unit designed for use with other components, a portion of a program code (e.g., software or firmware) executable by the processor 918 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for setting a sensing threshold for a touch panel in an electronic device, comprising:
acquiring a current ambient temperature of the electronic device;
acquiring a reportable sensing threshold corresponding to the current ambient temperature, wherein the reportable sensing threshold for the touch panel is a signal threshold for a touch signal above which the touch signal is reported to the electronic device as a valid touch signal intended by a user; and
setting the acquired reportable sensing threshold as the current reportable sensing threshold of the touch panel in the electronic device

2. The method according to claim 1, wherein acquiring the reportable sensing threshold corresponding to the current ambient temperature, comprises:
acquiring a temperature range to which the acquired ambient temperature belongs; and
acquiring the reportable sensing threshold corresponding to the acquired temperature range from a predetermined correspondence between at least one temperature range and at least one reportable sensing threshold.

3. The method according to claim 1, wherein acquiring the current ambient temperature of the electronic device comprises acquiring the current ambient temperature from a temperature sensor in the electronic device.

4. The method according to claim 1, wherein acquiring the current ambient temperature of the electronic device comprises acquiring a geographical position of the electronic device, and acquiring a current temperature corresponding to the geographical position from a server as the current ambient temperature of the electronic device.

5. The method according to claim 1, wherein the reportable sensing threshold corresponding to the current ambient temperature is acquired by a processor of the electronic device and wherein setting the acquired reportable sensing threshold as the current reportable sensing threshold of the touch panel in the electronic device comprises sending to a touch integrated circuit by the processor of the electronic device a setting instruction configured to instruct the touch integrated circuit to set the acquired reportable sensing threshold as the current reportable sensing threshold of the touch panel.

6. The method according to claim 1, wherein the reportable sensing threshold corresponding to the current ambient temperature is acquired by a touch integrated circuit for the touch panel and wherein setting the acquired reportable sensing threshold as the current reportable sensing threshold of the touch panel in the electronic device comprises setting by the touch integrated circuit the acquired reportable sensing threshold as the current reportable sensing threshold of the touch panel in the electronic device.

7. The method according to claim 1, further comprising detecting whether a glove touch mode is active for the touch panel, wherein the method or claim 1 is performed when the glove touch mode is active.

8. An apparatus for setting a reportable sensing threshold for a touch panel, comprising:
a memory having instructions stored therein; and
one or more processors, configured by the instructions to:
acquire a current ambient temperature;
acquire a reportable sensing threshold corresponding to the current ambient temperature; and
set the acquired reportable sensing threshold as the current reportable sensing threshold of the touch panel,
wherein the reportable sensing threshold for the touch panel at least partially determines the sensitivity of the touch panel.

9. The apparatus according to claim 8, wherein to acquire the reportable sensing threshold, the one or more processors, are further configured to:
acquire a temperature range to which the acquired ambient temperature belongs; and
acquire the reportable sensing threshold corresponding to the acquired temperature range from a predetermined correspondence between at least one temperature range and at least one reportable sensing threshold.

10. The apparatus according to claim 8, further comprising a temperature sensor, wherein the one or more processors, when executing the instructions to acquire the current ambient temperature, are configured to acquire the current ambient temperature from the temperature sensor.

11. The apparatus according to claim 8, further comprising a location sensor, wherein the one or more processors, are further configured to:
acquire a geographical position of the apparatus from the location sensor; and
acquire the current ambient temperature corresponding to the geographical position from a server as the current ambient temperature.

12. The apparatus according to claim 8, wherein the one or more processors, when executing the instructions to set the acquired reportable sensing threshold as the current reportable sensing threshold of a touch panel, are configured to send to a touch integrated circuit by the processors a setting instruction configured to instruct the touch integrated circuit to set the acquired reportable sensing threshold as the current reportable sensing threshold of the touch panel.

13. A non-transitory computer-readable storage medium having stored therein instructions that, when executed by a processor of an electronic device, cause the device to:
acquire a current ambient temperature of the electronic device;
acquire a reportable sensing threshold for a touch panel of the electronic device corresponding to the current ambient temperature; and
set the acquired reportable sensing threshold as the current reportable sensing threshold of the touch panel,
wherein a reportable sensing threshold for the touch panel is a signal threshold for a touch signal above which the touch signal is reported to the electronic device as a valid touch signal intended by a user.

14. The non-transitory computer-readable storage medium according to claim 13, wherein the instructions to acquire the reportable sensing threshold corresponding to the current ambient temperature comprise instructions to cause the electronic device to:
acquire a temperature range to which the acquired current ambient temperature belongs; and
acquire the reportable sensing threshold corresponding to the acquired temperature range from a predetermined correspondence between at least one temperature range and at least one reportable sensing threshold.

15. The non-transitory computer-readable storage medium according to claim 13, wherein the instructions to acquire the current ambient temperature of the electronic device comprise instructions to cause the electronic device to:
acquire the current ambient temperature from a temperature sensor in the electronic device.

16. The non-transitory computer-readable storage medium according to claim 13, wherein the instructions to acquire the current ambient temperature of the electronic device comprise instructions to cause the electronic device to:
acquire a geographical position of the electronic device; and
acquire a current temperature corresponding to the geographical position from a server as the current ambient temperature of the electronic device.

17. The non-transitory computer-readable storage medium according to claim 13, wherein the reportable sensing threshold corresponding to the current ambient temperature is acquired by the processor and wherein the instructions to set the acquired reportable sensing threshold as the current reportable sensing threshold of a touch comprise instructions to cause the electronic device to:
send to a touch integrated circuit by the processor of the electronic device a setting instruction to instruct the touch integrated circuit to set the acquired reportable sensing threshold as the current reportable sensing threshold of the touch panel.
